(19) United States
(12) Patent Application Publication
(10) Pub. No.: US 2011/0266437 A1
(43) Pub. Date: Nov. 3, 2011

(54) Method for chemical analysis and apparatus for chemical analysis

(75) Inventor: Seong Chan Park, Suwon (KR)

(73) Assignee: SAMSUNG ELECTRO-MECHANICS CO., LTD., Suwon (KR)

(21) Appl. No.: 12/926,461

(22) Filed: Nov. 18, 2010

(30) Foreign Application Priority Data
May 3, 2010 (KR) 10-2010-0041553

(51) Int. Cl. H01J 49/00; G01N 23/00

(52) U.S. Cl. 250/288; 250/307

(57) ABSTRACT

There are provided a method for chemical analysis and an apparatus for chemical analysis. The method for chemical analysis includes: dosing a targeted sample with ionizing gas; irradiating ion beams on the targeted sample; and analyzing the mass of fragment ions and molecular ions sputtered from the targeted sample by the collisional impact of the ion beams . The apparatus for chemical analysis includes: an ionizing gas doser that adds ionizing gas onto a targeted sample disposed in a vacuum chamber; an ion beam source that generates ion beams and irradiates them onto the targeted sample; and a mass spectrometer that analyzes the mass of fragment ions and molecular ions sputtered from the targeted sample by the collisional impact of the ion beams.

### CROSS-REFERENCE TO RELATED APPLICATIONS

This application claims the priority of Korean Patent Application No. 10-2010-0041553 filed on May 3, 2010, in the Korean Intellectual Property Office, the disclosure of which is incorporated herein by reference.

### BACKGROUND OF THE INVENTION

1. Field of the Invention

The present invention relates to a method for chemical analysis and an apparatus for chemical analysis, and more particularly, to a method for chemical analysis and an apparatus for chemical analysis having excellent detection sensitivity of chemical components on a surface of a targeted sample or over a targeted sample.

2. Description of the Related Art

Generally, secondary ion mass spectrometry (hereinafter referred to as SIMS) is used to analyze the chemical state of materials. SIMS is a chemical analysis technique that measures the mass of secondary ions sputtered from a sample surface to be analyzed in the course of the collision with primary ions such as Ar⁺, Cs⁺, O₂⁺, or the like, and identifies constituent matter within the sample. The SIMS analysis method has been used in various fields in which the micro and trace chemical analysis of surface matter is required in order to analyze pollutants on a semiconductor wafer or a PCB substrate, to investigate reaction intermediates of heterogeneous catalytic reactions, to analyze the components of geological samples and archeological relics, to analyze the chemical components of biological samples, and the like.

Recently, the size and concentration of surface matters to be analyzed have become even smaller with reductions in the size, thickness, and line width of electronic components. Further, the demand for analysis of surface materials having a large molecular weight has been increasing, as industrial polymer materials have become widely used and bio technology and the existing electric and electronic technology have converged.

In the SIMS analysis method, when primary ions having a certain amount of energy bombard a sample to be analyzed, the impinging ions dynamically and electronically interact with atoms within the sample, thereby sputtering secondary ions from the surface during the collision process.

In SIMS, as the name implies, the secondary ions that are sputtered by the primary ions are mass-analyzed. However, since the ionization probability of sputtered species is below 5% in general, more than 95% of them are sputtered as neutrals that can not be detected. Further, most molecules sputtered by the impact of the primary ions undergo severe fragmentation, being ejected mainly in the form of fragment ions. Thus, when both the size and concentration of surface matters to be analyzed are very small, there is a problem in that the signals of the secondary ions including intact molecular ions are too weak to be detected unambiguously.

### SUMMARY OF THE INVENTION

An aspect of the present invention provides a method for chemical analysis and an apparatus for chemical analysis having excellent detection sensitivity of chemical components on a surface of a targeted sample or over a targeted sample.

According to an aspect of the present invention, there is provided a method for chemical analysis, including: dosing a targeted sample with ionizing gas; irradiating ion beams onto the targeted sample; and analyzing the mass of fragment ions and molecular ions sputtered from the targeted sample by the collisional impact of the ion beams.

The ionizing gas may be introduced in the form of a molecular beam.

The ionizing gas may be mixed and introduced with inert gas.

The ionizing gas may be an acid gas or a basic gas.

The ionizing gas may be introduced simultaneously with vapor or alternately introduced with vapor.

The dosing the surface of a targeted sample with the ionizing gas, the targeted sample may be cooled to 150K or less.

The ion beam may collide with the surface of the targeted sample to analyze the components of the surface of the targeted sample.

The components may be analyzed depending on the depth of the targeted sample by etching the ion beams in a depth direction from the surface of the targeted sample.

According to another aspect of the present invention, there is provided an apparatus for chemical analysis, including: an ionizing gas doser that adds ionizing gas onto a targeted sample disposed in a vacuum chamber; an ion beam source that generates ion beams and irradiates them onto the targeted sample; and a mass spectrometer that analyzes the mass of fragment ions and molecular ions sputtered from the targeted sample by the collision of the ion beams.

The ionizing gas doser may include: a feedthrough load that is linearly moved; and a flexible tube that is connected to the feedthrough load and expands and contracts due to a linear motion of the feedthrough load.

The ionizing gas doser may include: a leak valve that controls the inflow of the ionizing gas; and a gas tube that is connected to the leak valve.

The ionizing gas doser may include: an expander that expands the inflowing ionizing gas in a vacuum state; and a skimmer that is included in the expander and focuses the ionizing gas in a small area and converts the ionizing gas into the form of a molecular beam.

The expander may include a vacuum gauge that monitors the pressure of the ionizing gas.

The expander may further include an aperture that reduces the diameter of the focused molecular beam.

### BRIEF DESCRIPTION OF THE DRAWINGS

FIG. 1 is a cross-sectional view schematically showing an apparatus for chemical analysis according to an exemplary embodiment of the present invention;

FIGS. 2A and 2B are cross-sectional views showing the structure and operation of the ionizing gas doser according to an exemplary embodiment of the present invention;

FIG. 3 is a cross-sectional view showing the structure of the ionizing gas doser according to another exemplary embodiment of the present invention;

FIG. 4A is a mass spectrum according to an example of the present invention; and

FIG. 4B is a mass spectrum according to a comparative example.

### DETAILED DESCRIPTION OF THE PREFERRED EMBODIMENT

Exemplary embodiments of the present invention will now be described in detail with reference to the accompanying drawings. The exemplary embodiments of the present invention may be modified in many different forms and the scope of the invention should not be limited to the embodiments set forth herein. Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components.

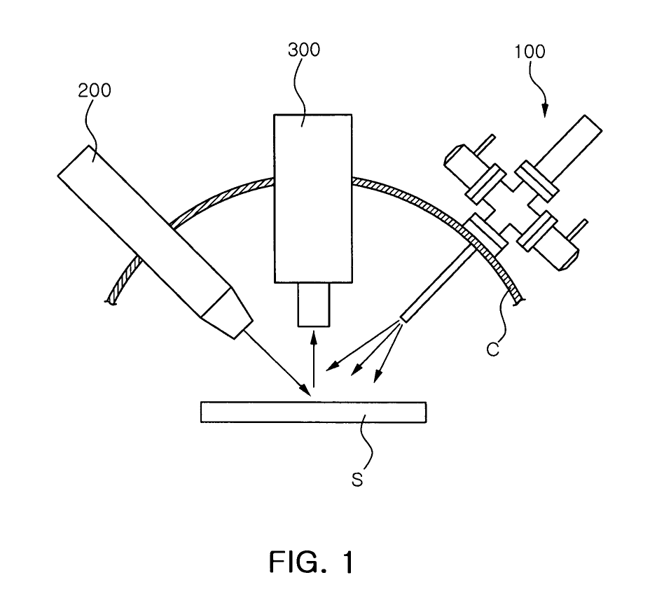

FIG. 1 is a cross-sectional view schematically showing an apparatus for chemical analysis according to an exemplary embodiment of the present invention.

A method for chemical analysis according to the present invention will be described with reference to FIG. 1.

First, a targeted sample S whose components should be analyzed is disposed in a vacuum chamber C. The targeted sample is not especially limited. For example, the targeted sample may be a semiconductor wafer, a PCB substrate, an organic thin film material, a biological sample or the like.

Thereafter, the targeted sample S is subjected to chemical pretreatment. The chemical pretreatment may be performed by injecting ionizing gas onto the surface of the targeted sample. In this case, it is preferable that the ionizing gas is intensely injected onto the targeted sample without affecting a vacuum formed in the vacuum chamber. To this end, a gas dosing unit 100 for injecting the ionizing gas may be disposed to be close to the targeted sample S. However, the gas dosing unit disposed to be close to the targeted sample S can distort an electric field around the targeted sample, such that it is preferable that it is disposed to be spaced apart from the targeted sample S after injecting the ionizing gas. This can be realized by the apparatus for analyzing the components of the targeted sample according to the present invention, which will be described below.

Further, the ionizing gas may be injected onto the targeted sample in the form of a molecular beam. The ionizing gas is expanded and is then focused by a skimmer, or the like, such that it may be in the form of a molecular beam.

The ionizing gas mixed with inert gas such as Ar, or the like, in order to perform the more reproducible injection may be used.

Any ionizing gas that can ionize materials existing on the targeted sample can be used. For example, an acid gas or a basic gas may be used.

Acid gas having a lower proton affinity than materials existing in the targeted sample may be used. For example, a strong acid such as HCl, or the like may be used.

When HCl is used as the acid gas, protons H⁺ are transferred to organic molecules X existing in the targeted sample, such that ions in an HX⁺ type may be previously formed. The reason is that most organic molecules existing in the targeted sample have a higher proton affinity than HCl.

Further, the targeted sample may be cooled to 150 K or lower. The targeted sample is cooled, which helps the ionizing gas to adhere to the surface of the targeted sample for efficient ion formation.

In addition, the ionizing gas may be injected simultaneously with water vapor or may be alternately injected with water vapor. The proton transfer efficiency of the acid gas may be improved by water molecules which are adsorbed next to the acid gas.

Next, the ion beams collide with the targeted sample. The focused ion beams have high energy (several to several tens of keV) . When the ion beams collide with the targeted sample, atoms or molecules on the surface of the targeted sample are detached from the surface of the targeted sample, which is then ejected into the vacuum.

In this case, some portions of atoms or molecules that are ejected are ionized to form secondary ions. In the case of polyatomic molecule, various fragment ions are generated by a fragmentation process.

The sputtered secondary ions are introduced into a mass spectrometer 300. The mass of the introduced secondary ions is measured by the mass spectrometer to analyze the components of the targeted sample.

The ion beams may use various kinds of ions, for example, inert gas ion such as Ar⁺, alkali metal ion such as Cs⁺, O₂⁺, Biₙ⁺, C₆₀⁺, Ga⁺, or the like, according to the purpose of the user.

The fragment ions and the molecular ions introduced into the mass spectrometer are separated and detected according to their mass-to-charge ratios (m/q) to produce the mass spectrum and the components of the targeted sample may be identified by the interpretation of the mass analysis spectrum.

As the mass spectrometer, various kinds of mass spectrometers such as a time-of-flight mass spectrometer, a quadrupole mass spectrometer, an electromagnetic sector spectrometer, or the like, may be used.

Damage to the surface layer of the targeted sample may be minimized by reducing the flux of the ion beam. The components of the surface of the targeted sample may be analyzed by the above-mentioned method.

Alternatively, the distribution of the chemical components depending on the depth of the targeted sample can be analyzed by increasing the flux of the ion beams and etching the surface of the targeted sample with the ion beams in a depth direction from the surface of the targeted sample. In this case, the chemical distribution depending on the depth can be more effectively analyzed by separately using the ion beams suitable for etching and the ion beams suitable for analysis. Further, in order to increase the flux of the ion beams, one or more ion beams may be used.

The general SIMS method traces the chemical components (molecules or atoms) of the targeted sample on the basis of the mass spectrum of the secondary ions.

Since the mass spectrum for each material is different, theoretically, the chemical components of the targeted sample may be easily investigated in the case that a mass spectrum library for widely varied materials is built. However, the spectrum may be largely affected by the kinds of ion beams and targeted samples, collision energy, scattering angle, and the structural characteristics of the surface of the targeted sample, such that the use of the library is limited.

In this case, the signal of the molecular ion sputtered without being fragmented is critical information in analyzing the mass spectrum.

In the related art, the signal of the molecular ion can be very weak or absent, especially when the analyte material on the sample is extremely small and rarefied, such that it is impossible to accurately investigate the chemical component of the targeted sample.

According to the present invention, however, the targeted sample is already ionized by performing the chemical pretreatment on the targeted sample, such that the emission of the molecular ion is increased, thereby making it possible to facilitate the analysis of the mass spectrum. The molecular ion which can directly show the identity of molecule is therefore critical information in the determination of the components of the targeted sample.

In addition, according to the present invention, the emission of the fragment ion in addition to the molecule ion is increased, such that it is possible to analyze a very small amount of a sample.

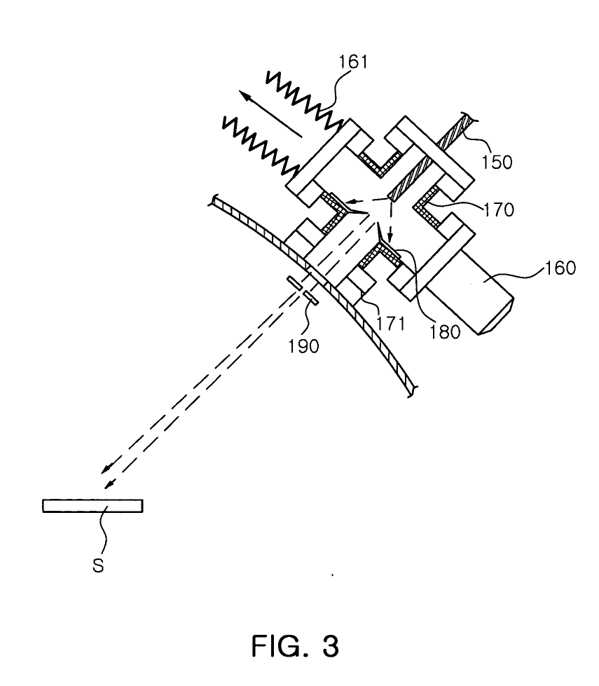

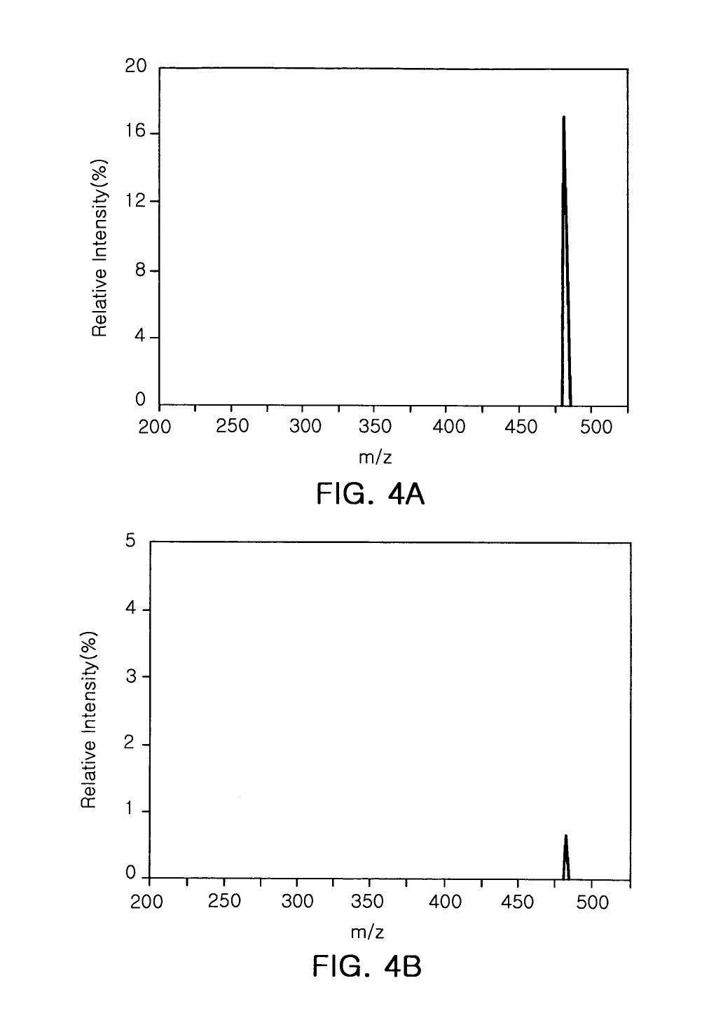

FIG. 4A is a mass spectrum according to an example of the present invention and FIG. 4B is a mass spectrum according to a comparative example.

First, an organic material (Tinubin 770, molecular weight 481 amu) was film-cast onto the silicon substrate. Thereafter, according to an example of the present invention, the mass spectrum was obtained by exposing an organic material film to the ionizing gas (HCl), colliding the ion beams with the surface of the organic material film, and then, introducing the sputtered ions into the mass spectrometer (FIG. 4A).

Further, in the comparative example, the mass spectrum was obtained by colliding the ion beams with the surface the organic material film without dosing the ionizing gas and then introducing the sputtered ions into the mass spectrometer.

FIG. 4 shows the case in which the signal near 481 amu is largely increased by the ionization gas (HCl) pretreatment. The signal from the neat organic film, expressed by a dashed line is barely distinguishable from noise level, while the signal from the HCl-treated organic film, shown by a solid line is increased by around 30 times, having a distinct peak.

Hereinafter, the apparatus for chemical analysis according to an exemplary embodiment of the present invention will be described with reference to FIGS. 1 to 3.

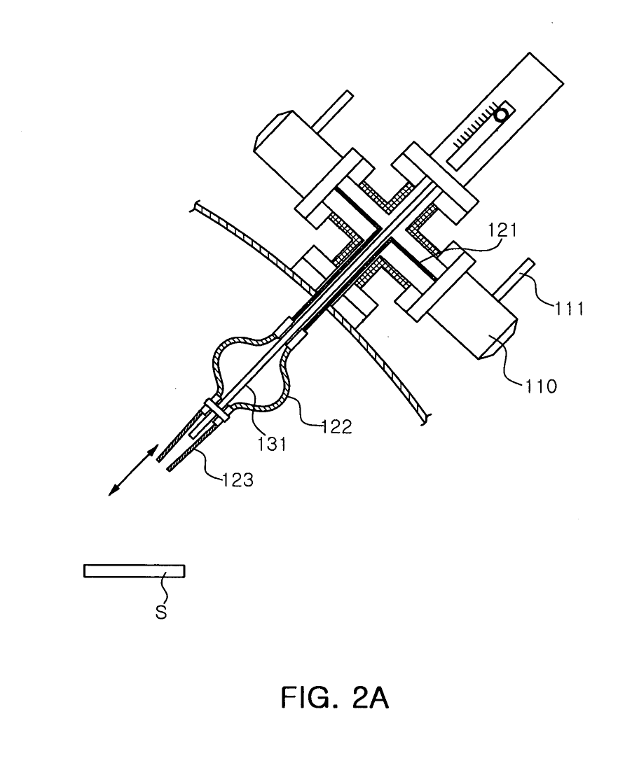

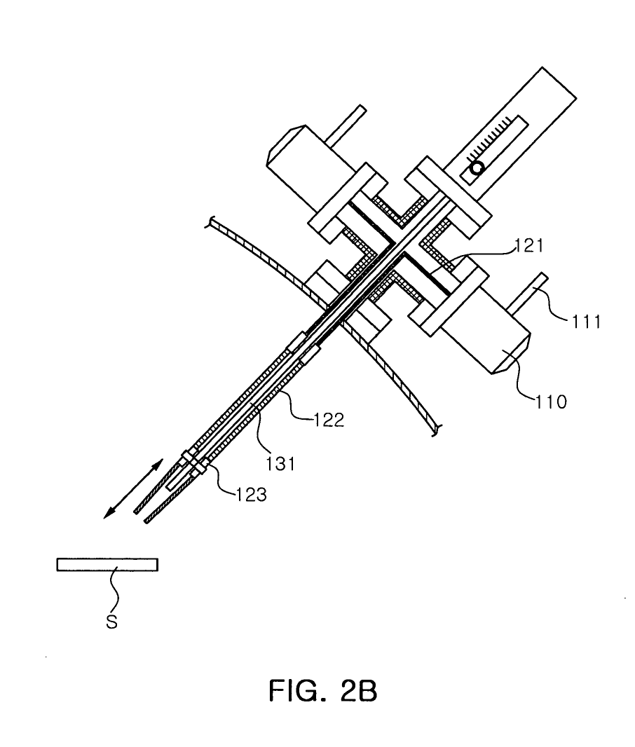

FIG. 1 is a cross-sectional view schematically showing the apparatus for chemical analysis according to an exemplary embodiment of the present invention, FIGS. 2A and 2B are cross-sectional views showing the structure and operation of the ionizing gas doser according to an exemplary embodiment of the present invention, and FIG. 3 is a cross-sectional view showing the structure of the ionizing gas doser according to another exemplary embodiment of the present invention.

The apparatus for chemical analysis according to the exemplary embodiment of the present invention includes an ionizing gas doser 100 that introduces the ionizing gas onto the targeted sample disposed in the vacuum chamber, an ion beam generator 200 that collides the ion beams with the targeted sample, and a mass spectrometer 300 that analyzes the mass of the fragment and molecular ions sputtered from the targeted sample by the impact of the ion beams.

The targeted sample S whose chemical components should be analyzed is disposed in the vacuum chamber C. The ionizing gas is added onto the targeted sample S by the ionizing gas doser 100.

In this case, it is preferable that the ionizing gas doser 100 is disposed to be close to the targeted sample S so that the ionizing gas is intensely directed to the targeted sample without affecting the vacuum formed in the vacuum chamber. However, the ionizing gas doser 100 disposed near the targeted sample S can distort the electric field around the targeted sample, such that it is preferable that it is disposed to be removed from the targeted sample S after introducing the ionizing gas S.

The ionizing gas doser according the exemplary embodiment of the present invention will be described in more detail with reference to FIGS. 2A and 2B.

According to the present exemplary embodiment, the ionizing gas doser includes a feedthrough rod 131 and a flexible tube 122 that is connected to the feedthrough rod.

The ionizing gas is introduced into the gas tube 121 through a gas inlet 111 of a leak valve 110. The amount of the ionizing gas introduced can be controlled by the leak valve 110.

A portion of the gas tube may be configured to include the flexible tube 122 and the flexible tube 122 may be connected to a capillary array 123.

The amount and flux of the ionizing gas introduced can be controlled by the leak valve 110.

The feedthrough rod 131 is linearly moved and the flexible tube 122 connected to the feedthrough rod 131 expands and contracts due to a linear motion. The flexible tube 122 expands to be close to the targeted sample S, such that the ionizing gas can be intensely directed onto the targeted sample. Thereafter, it may be spaced apart from the targeted sample S during the steps of firing the ion beams and analyzing the mass.

Referring to FIG. 3, the ionizing gas doser according to another exemplary embodiment of the present invention introduces the ionizing gas into an expander 170 through a nozzle 150 and the ionizing gas expands to a vacuum state in the expander 170. The expander may include a vacuum pump 161. The pressure of the ionizing gas is maintained at 10−3 mbar or less by the vacuum pump 161. The pressure may be monitored by a vacuum gauge 160 included in the expander.

The ionizing gas passing through the skimmer 180 included in the expander 170 is in the form of a molecular beam in which the gas molecules are tightly focused in a small region, which may be directed onto the targeted sample.

In order to further reduce the cross-sectional area of the molecular beam, an aperture 190 may be provided and an interval between the nozzle 150 and the aperture 190 can be controlled.

After the ionizing gas is directed onto the targeted sample S, the ion beams fired by the ion beam generator 200 collide with the targeted sample. Thereafter, the fragment and molecular ions sputtered from the targeted sample by the impact of the ion beams are introduced into the mass spectrometer 300.

The components of the targeted sample can be determined by analyzing the mass spectrum of the fragment and molecular ions.

As set forth above, the emission of fragment and molecular ions is increased, thereby making it possible to facilitate the analysis of the mass spectrum. Therefore, the chemical components of the targeted sample can be easily determined. In addition, the present invention can improve the detection sensitivity and lower the detection limit of the chemical components of the targeted sample.

The present invention increases the emission of the fragment and molecular ions, thereby making it possible to improve the detection sensitivity lower the detection limit of the chemical components of the targeted sample.

In addition, the present invention can make it possible to use low-energy ion beams, thereby reducing the surface damage of the targeted sample.

The present invention can be used to analyze pollutants on the surface of the semiconductor wafer or the PCB substrate, or the like, analyze the components of the organic thin film material, analyze the chemical components of the biological samples, or the like, and can be used in various fields that require the analysis of a trace amount of molecules or micro-sized matter.

While the present invention has been shown and described in connection with the exemplary embodiments, it will be apparent to those skilled in the art that modifications and variations can be made without departing from the spirit and scope of the invention as defined by the appended claims.

What is claimed is:

1. A method for chemical analysis, comprising:
dosing the surface of a targeted sample with ionizing gas;
irradiating ion beams onto the targeted sample; and
analyzing the mass of fragment ions and molecular ions sputtered from the targeted sample by the collisional impact of the ion beams.

2. The method for chemical analysis of claim 1, wherein the ionizing gas is introduced in the form of a molecular beam.

3. The method for chemical analysis of claim 1, wherein the ionizing gas is mixed and introduced with inert gas.

4. The method for chemical analysis of claim 1, wherein the ionizing gas is an acid gas or a basic gas.

5. The method for chemical analysis of claim 1, wherein the ionizing gas is introduced simultaneously with vapor or alternately injected with vapor.

6. The method for chemical analysis of claim 1, wherein the dosing the surface of a targeted sample with the ionizing gas, the targeted sample is cooled to 150K or less.

7. The method for chemical analysis of claim 1, wherein the ion beam collides with the surface of the targeted sample to analyze the components of the surface of the targeted sample.

8. The method for chemical analysis of claim 1, wherein components are analyzed depending on the depth of the targeted sample by etching the ion beams in a depth direction from the surface of the targeted sample.

9. An apparatus for chemical analysis, comprising:
an ionizing gas doser that adds ionizing gas onto a targeted sample disposed in a vacuum chamber;
an ion beam source that generates ion beams and irradiates them onto the targeted sample; and
a mass spectrometer that analyzes the mass of fragment ions and molecular ions sputtered from the targeted sample by the collisional impact of the ion beams.

10. The apparatus for chemical analysis of claim 10, wherein the ionizing gas doser includes:
a feedthrough load that is linearly moved; and
a flexible tube that is connected to the feedthrough load and expands and contracts by a linear motion of the feedthrough load.

11. The apparatus for chemical analysis of claim 9, wherein the ionizing gas doser includes:
a leak valve that controls the inflow of the ionizing gas; and
a gas tube that is connected to the leak valve.

12. The apparatus for chemical analysis of claim 9, wherein the ionizing gas doser includes:
an expander that expands the inflowing ionizing gas in a vacuum state; and
a skimmer that is included in the expander and focuses the ionizing gas in a small area and converts the ionizing gas into the form of a molecular beam.

13. The apparatus for chemical analysis of claim 12, wherein the expander includes a vacuum gauge that monitors the pressure of the ionizing gas.

14. The apparatus for chemical analysis of claim 12, wherein the expander further includes an aperture that reduces the diameter of the focused molecular beam.
